(19) United States
(12) Patent Application Publication
(10) Pub. No.: US 2011/0109555 A1
(43) Pub. Date: May 12, 2011

(54) INTERFACE SYSTEM INCLUDING TRACKBALL

(75) Inventor: Ross Cameron Miller, Hilliard, OH (US)

(73) Assignee: HONDA MOTOR CO., LTD., Tokyo (JP)

(21) Appl. No.: 12/613,701

(22) Filed: Nov. 6, 2009

(51) Int. Cl. G06F 3/033

(52) U.S. Cl. 345/167

(57) ABSTRACT

A user interface system includes a display, a user interface including a trackball, a brake assembly configured to cooperate with the trackball to limit rotational movement of the trackball to about predetermined axes, and a control system in electrical communication with the display, the user interface, and the brake assembly. The control system is configured to operate in at least one input status mode including a first input status mode and a second input status mode based on desired directional input of the trackball. The control system includes a trackball control module. When in the first input status mode, the trackball control module communicates with the brake assembly to restrict rotation of the trackball to about a first axis. When in the second input status mode, the trackball control module communicates with the brake assembly to restrict rotation of the trackball to about a second axis.

### BACKGROUND

A trackball can allow for directional input about a plurality of axes. The trackball can rotate about a number of different axes, and can be referred to as omni-directional. A trackball is a cursor control (or other visual indicator) apparatus in which the operator rotates the trackball, which typically protrudes from a housing, allowing the trackball to be rotated by the hand of the operator. The motion of the trackball is translated into cursor (or other visual indicator) motion by sensors, such as light sensors found in the housing.

Electronic systems, such as vehicle electronic systems including an HVAC system, an audio system (e.g., satellite and terrestrial radio, CD player, MP3 player, cassette player), a navigation system, a video system (e.g., rear entertainment systems), and other systems are controlled by an operator inputting commands through a user interface. Many known electronic systems use knobs and buttons to control the aforementioned electronic systems. For example, knobs and buttons are used to control the settings (e.g., cabin temperature) for the HVAC system and to control the settings (e.g., radio station setting) of the audio system.

Operators of the aforementioned electronic systems have grown accustomed to inputting commands through a user interface via some sort of directional input. For example, when changing a radio station setting, operators have grown accustomed to rotating a knob about a single axis. With regard to changing temperature settings, for example in a vehicle cabin, up/down buttons and rotating knobs have been provided to regulate the temperature. Accordingly, operators have grown accustomed to left-to-right directional input, for example when changing a radio station setting, as well as up and down motion, for example when changing the temperature setting.

Since electronic system operators have grown accustomed to directional input when inputting commands into a user interface, an omni-directional trackball, which can provide more freedom of operation as compared to knobs and buttons, could be awkward for an operator to manipulate when inputting the desired commands.

### SUMMARY

An example of a user interface system that can overcome at least some of the aforementioned shortcomings includes a display, a user interface including a trackball, a brake assembly configured to cooperate with the trackball to limit rotational movement of the trackball to about predetermined axes, and a control system in electrical communication with the display, the user interface, and the brake assembly. The control system is configured to operate in at least one input status mode including a first input status mode and a second input status mode based on desired directional input of the trackball. The control system includes a trackball control module. When in the first input status mode, the trackball control module communicates with the brake assembly to restrict rotation of the trackball to about a first axis. When in the second input status mode, the trackball control module communicates with the brake assembly to restrict rotation of the trackball to about a second axis.

An example of a vehicle interface system that can overcome at least some of the aforementioned shortcomings includes a display mounted in a vehicle cabin of a vehicle, a control system on the vehicle and in electrical communication with the display, and a user interface mounted in the vehicle cabin and in electrical communication with the control system. The user interface includes a trackball. An axis about which the trackball rotates is controlled by the control system based on input received from the user interface.

An example of a method for receiving input via a user interface that can overcome at least some of the aforementioned shortcomings includes determining an input status mode based on desired directional movement of a trackball on a user interface, and restricting rotation of the trackball to about a single axis of the trackball based on the determined input status. The trackball is in communication with a control system, which is also in communication with the user interface.

### BRIEF DESCRIPTION OF THE DRAWINGS

FIG. 1 depicts a vehicle cabin of a vehicle including a display and a user interface. A control system is schematically depicted in electrical communication with the display and the user interface.

FIG. 2 schematically depicts a trackball of the interface depicted in FIG. 1, a brake assembly that cooperates with the trackball and a trackball control module, which is a portion of the control system.

FIG. 3 depicts the vehicle cabin and user interface shown in FIG. 1 with the display presenting information in an input status mode that is different than the input status mode depicted in the FIG. 1.

FIG. 4 schematically depicts the trackball and brake assembly shown in FIG. 2 in an input status mode that is different than the input status mode shown for FIG. 2.

FIG. 5 is a schematic depiction of the control system depicted in FIG. 1.

FIG. 6 is flow diagram depicting a method for receiving input via a vehicle user interface.

FIG. 7 is another flow diagram depicting a method for determining an input status mode.

FIG. 8 is a schematic depiction of an electronic device including a user interface system having a trackball.

FIG. 9 is a schematic depiction of a trackball housing received in a housing including a trackball switch.

### DETAILED DESCRIPTION

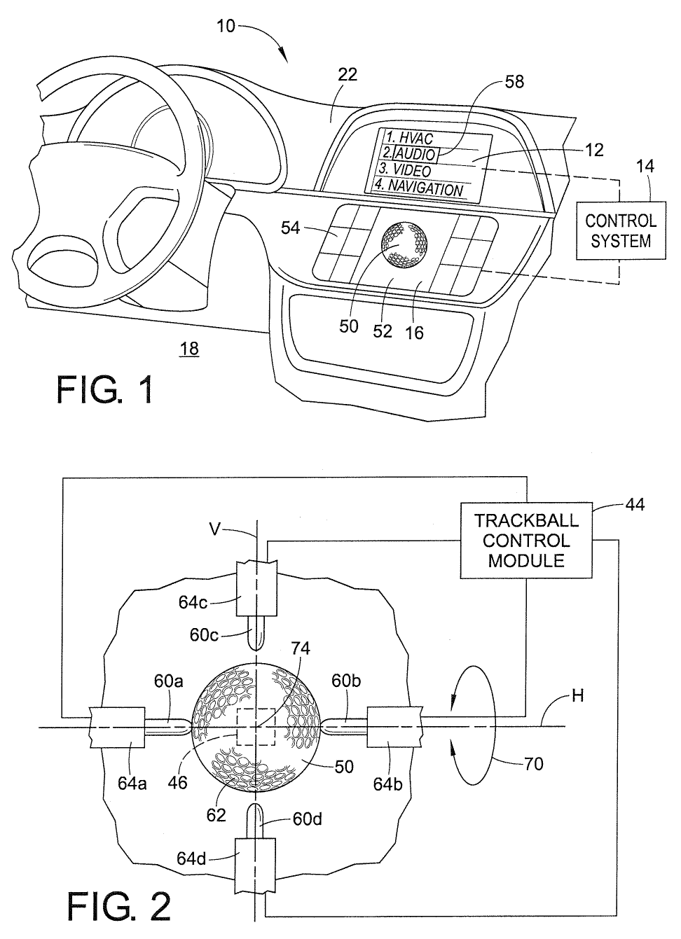

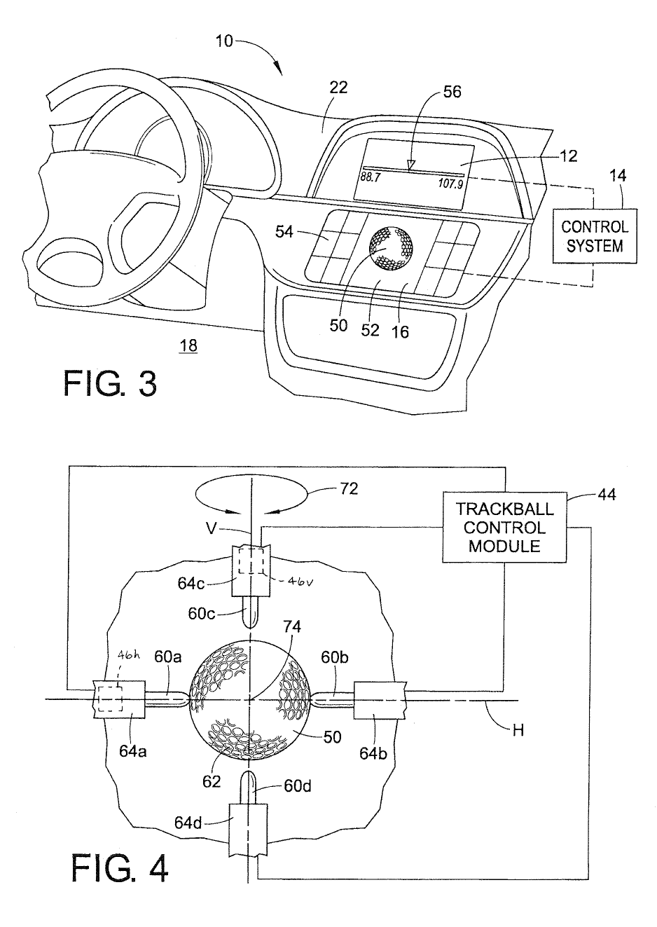

The following is a description of systems and methods that are useful to receive input commands for controlling the operation of electronic systems. Examples of such systems are described so that one skilled in the art can construct these systems, however, the embodiments that are defined by the appended claims are not limited only to the embodiment(s) described herein. FIGS. 1 and 3 are schematic depictions of a vehicle interface system showing a flow of information in the system. FIGS. 1 and 3 are provided for the purpose of explaining interrelationships between various data and components in the system, however, the invention as defined in the appended claims is not limited to only the arrangement that is shown in FIGS. 1 and 3. Moreover, the user interface system need not be used with a vehicle, but instead could be a system found in an electronic device, such as a computer system or another electronic device having an interface through which input is received.

FIG. 1 schematically depicts a vehicle interface system 10 including a display 12, a control system 14, and a user interface 16. An operator or a passenger of a vehicle that includes the vehicle interface system 10 can control vehicle systems via the user interface 16. Such vehicle systems can include an HVAC system, an audio system, a video system, a navigation system, power window and sunroof controls, and a home automation system, among others.

The display 12 can be mounted in a vehicle cabin 18 of the vehicle. In the depicted embodiment, the display 12 is mounted on or below a dashboard 22 found in the vehicle cabin 18. The display 12 can present information to the operator or passenger of the vehicle regarding the device or system that is to be controlled by the user interface 16. The display 12 can also present information regarding other systems that may not be controlled through the user interface 16, for example the amount of fuel in the vehicle fuel tank, miles per gallon for operation of the vehicle, speed of the vehicle, etc. The display 12 can be any suitable display device, such as an LED/LCD display, a CRT display or other known display device. The display 12 can include a touch-sensitive surface, which can be considered as part of the user interface 16, to allow the operator or passenger of the vehicle to touch display images presented on the display to select those images and an associated setting or function for that image.

The control system 14 is found on the vehicle, although it is not typically visible to the operator of the vehicle during normal operation of the vehicle. The control system 14 is in electrical communication with the display 12 and the user interface 16. The control system 14 can include a processor, processors, or other similar devices capable of running software that allows control system to communicate with the display 12, the interface 16, and the aforementioned vehicle systems.

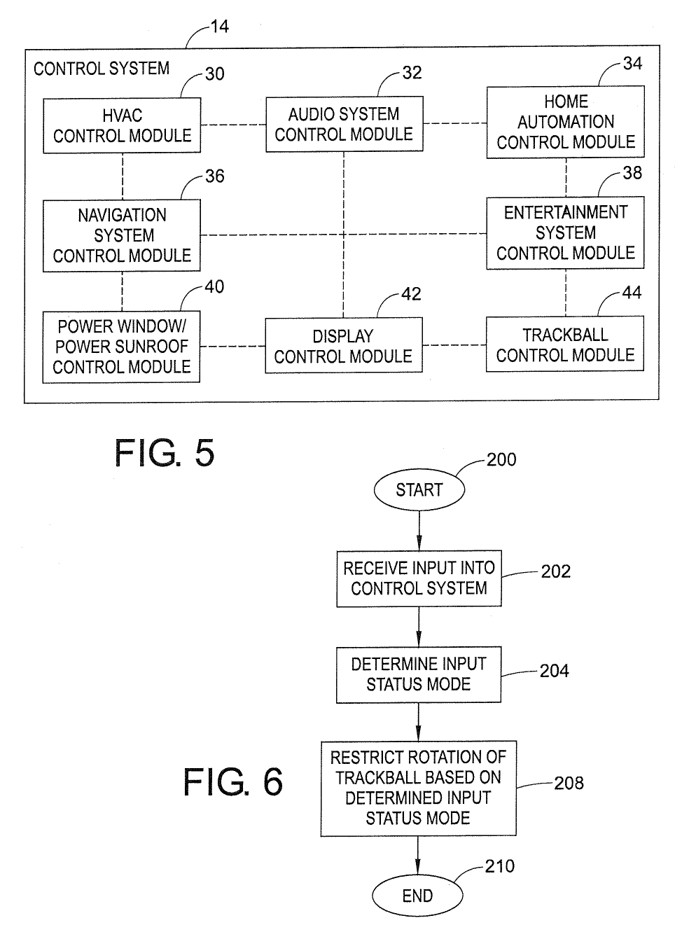

With reference to FIG. 5, the control system 14 can include a plurality of control modules that are in electrical communication with one another to control the operation of the aforementioned vehicle systems. For example, the control system 14 can include an HVAC control module 30, an audio system control module 32, a home automation control module 34, a navigation system control module 36, a video system control module 38, a power windows/power sunroof control module 40, a display control module 42 and a trackball control module 44. The aforementioned control modules can be located on different pieces of hardware and in different pieces of software. The control modules can be components of an algorithm found in a software program. Moreover, some of the modules can be combined with other modules to control more than one of the aforementioned vehicle systems.

Each of these control modules is for controlling an associated vehicle system. For example, the HVAC control module 30 can control components of the HVAC system (e.g., a fan, a compressor, a condenser, a heating element, and louvers) for the vehicle, which can be used to regulate the temperature of the vehicle cabin. The audio system control module 32 can control the audio system (e.g. radio and other audio devices) of the vehicle. The home automation control module 34 can control signal generators such as garage door openers and other home peripheral systems that can communicate with the vehicle. The navigation system control module 36 can control the navigation system for the vehicle. The video system control module 38 can control a rear entertainment system for the vehicle. The power window/power sunroof control module 40 can control the power windows and/or the power sunroof for the vehicle. The display control module 42 can control the images presented on the display 12. The trackball control module 44 can control an axis about which a trackball 50, which in the illustrated embodiment is a component of the user interface 16, rotates. Each of these control modules is in electrical communication with the user interface 16 for receiving commands inputted through the user interface.

With reference back to the embodiment illustrated in FIG. 1, the user interface 16 can include the trackball 50. The trackball 50 is similar to a conventional trackball in that the trackball 50 extends from a housing 52 so that the hand of an operator, which can be an operator of the vehicle or a passenger, can manipulate the trackball 50. The trackball 50 cooperates with conventional sensors (not shown) to control the location of a visual indicator, such as a cursor, pointer 56 (FIG. 3), selection box 58 (FIG. 1), arrow, or highlighting of a selected text/image presented on the display 12.

The user interface 16 can also include a trackball switch 46. The trackball switch 46 can be a contact switch. When the trackball 50 is pushed into the housing 52 or into the dashboard 22, the trackball switch 46 would close, allowing input to be detected. Accordingly, the trackball switch 46 can be actuated by an operator pressing the trackball into the housing 52. FIG. 2 depicts the trackball switch beneath the trackball 50. The trackball switch 46 could also be mounted elsewhere in the housing 52, which will be described in more detail below.

The trackball 50 is capable of rotating about a plurality of axes; however, an axis about which the trackball 50 rotates can also be controlled by the control system 14, by way of the trackball control module 44, based on input received from the user interface 16. The trackball control module 44, and thus the control system 14, is configured to determine an input status mode based on a vehicle system selected to be controlled by an operator or passenger of the vehicle via the user interface 16.

The trackball control module 44, and thus the control system 14, can also be configured to determine an input status mode based on the desired directional input of the trackball 50. For example, where the desired directional input is in a left-to-right (or right-to-left) direction, the trackball control module 44 can restrict the rotational movement of the trackball 50 to about a vertical axis. As another example, where the desired directional input is in an up and down direction, the trackball control module 44 can restrict the rotational movement of the trackball 50 to about a horizontal axis. This desired directional input can be a function of the device or system (e.g. an HVAC system, an audio system, a video system, a navigation system, power window and sunroof controls, and a home automation system) for which input is being sought by the control system 14 via the trackball 50.

With continued reference to the embodiment illustrated in FIG. 1, the depicted user interface 16 also includes a plurality of buttons, or keys, 54 that can be depressed by the operator to input signals to the control system 14 via switches and/or sensors (not visible) actuated by the buttons 54.

With reference to FIG. 2, the vehicle interface system 10 also includes brake members, or pins 60a, 60b, 60c, 60d that makeup components of a brake assembly, which can control the axis about which the trackball 50 rotates. For example, the brake assembly in the illustrated embodiment is in communication with the control system 14, via the trackball control module 44, and is configured to cooperate with the trackball 50 to limit rotational movement of the trackball to about two mutually perpendicular axes: a horizontal axis H and a vertical axis V. The terms “horizontal” and “vertical” as used herein are general terms and are not intended to require each axis to be either exactly vertical or exactly horizontal with respect to a datum. In the illustrated embodiment, the vertical axis V is perpendicular to the horizontal axis H and resides in the same plane; however, the vertical axis V can be nearly perpendicular to the horizontal axis H and each axis can reside in slightly different planes.

As more clearly seen in FIG. 2, the trackball 50 can include a plurality of dimples 62 (similar to dimples found on a conventional golf ball). The pins 60a, 60b, 60c and 60d can be received in respective dimples 62 to restrict the axis about which the trackball 50 rotates. The brake assembly includes the plurality of brake members, or pins 60a, 60b, 60c and 60d, and respective actuators 64a, 64b, 64c and 64d (one actuator for each pin is shown in the depicted embodiment). Each actuator 64a, 64b, 64c and 64d is in communication with the control system 14 via the trackball control module 44 and controls the movement of the respective pin 60a, 60b, 60c and 60d along a respective axis. Examples of suitable actuators include solenoid actuators and linear motors. Each actuator 64a, 64b, 64c and 64d can receive power from a power source such as the vehicle car battery (not shown).

As discussed above, the trackball switch 46 can be mounted elsewhere in the housing 52. For example, FIG. 4 depicts a trackball switch 46h beneath at least one of the actuators, actuator 64a in FIG. 4, in the horizontal axis H and a trackball switch 46v beneath at least one of the actuators, actuator 64c in FIG. 4, in the vertical axis V. FIG. 9 depicts the trackball housing 52, which houses the trackball 50, the sensors (not shown), the actuators (not shown but similar to actuators 64a, 64b, 64c and 64d), and the locking pins (not shown but similar to locking pins 60a, 60b, 60c and 60d) mounted in the dashboard 22 (or another housing, for example, where the user interface is not found in a vehicle). For the embodiment depicted in FIG. 9, the entire assembly, i.e. the trackball 50, the housing and the components found in the housing, would move when depressed by an operator. Downward movement of the housing 52 (per the orientation shown in FIG. 9) would result in actuation of the trackball switch 46. In each embodiment, the trackball switch can include a suspension that would bias the switch actuator in a direction opposite the direction that the trackball 50 is to be depressed.

As discussed above, the control system 14, and more particularly the trackball control module 44, is configured to determine at least one input status mode based on input received from the user interface 16. The at least one input status mode can include a vertical (first) input status mode, a horizontal (second) input status mode, and an omni-directional (third) input status mode. Additional input status modes could be provided, such as diagonal input status modes, which would require modifications to the brake assembly described above to restrict rotation of the trackball about other axes.

The input status modes are related to directional input that is received through the trackball 50. The vehicle interface system 10 is shown in the vertical input status mode in FIGS. 1 and 2. When in the vertical input status mode, the trackball control module 44 can communicate with the brake assembly, e.g., pins 60a-60d and actuators 64a-64d, to restrict rotation of the trackball 50 to about a horizontal axis H as depicted by an arrow 70 shown in FIG. 2. Accordingly, when in the vertical input status mode, input can be received from an operator of the trackball 50 in an up and down, or vertical, direction. When in the vertical input status mode, at least one brake member, pins 60a and 60b in the illustrated embodiment, contacts the trackball 50 to limit rotation of the trackball to about the horizontal axis H.

With reference to FIGS. 3 and 4, the vehicle interface system 10 is depicted in the horizontal input status mode. When in the horizontal input status mode, the trackball control module 44 can communicate with the brake assembly, e.g., pins 60a-60d and actuators 64a-64d, to restrict rotation of the trackball 50 to about the vertical axis V as depicted by an arrow 72 shown in FIG. 4. When in the horizontal input status mode, at least one brake member, pins 60c and 60d in the embodiment depicted in FIG. 4, contacts the trackball 50 to limit rotation of the trackball to about the vertical axis V. Accordingly, when in the horizontal input status mode, input can be received from an operator of the trackball 50 in a left-to-right or right-to-left, e.g. horizontal, direction.

With reference back to FIG. 2, upon entering into the vertical input status mode, the control system 14 sends via the trackball control module 44 a signal to the actuators 64a and 64b to result in movement of the respective brake pins 60a and 60b, respectively, toward a center 74 of the trackball 50. In the vertical input status mode, the pins 60c and 60d, also referred to as the vertical pins, are spaced from the trackball 50 so as to not contact the trackball. Each pin 60a, 60b, also referred to as horizontal pins, can reside in a respective dimple 62 on opposite sides of the vertical axis V and aligned along the horizontal axis H. With the pins 60a and 60b contacting the trackball 50 along the horizontal axis H, rotation of the trackball 50 is restricted to about the horizontal axis. Accordingly, the brake assembly includes at least two horizontal pins 60a and 60b that align along the horizontal axis H, which extends through the center 72 of the trackball 50. Each horizontal pin 60a and 60b is moveable by a respective actuator 64a and 64b in the horizontal axis H.

With reference back to FIG. 4, upon entering into the horizontal input status mode, the control system 14 sends via the trackball control module 44 a signal to the actuators 64c and 64d to result in movement of the respective brake pins 60c and 60d, respectively, toward a center 74 of the trackball 50. When in the horizontal input status mode, the horizontal pins 60a and 60b are spaced from the trackball 50 and the vertical pins 60c and 60d contact the trackball 50. The brake assembly can also include at least two vertical pins, e.g. pins 60c and 60d, that align along the vertical axis V, which extends through the center 72 of the trackball 50. Each vertical pin 60c and 60d is moveable by a respective actuator 64c and 64d in the vertical axis V. With reference to FIG. 4, each vertical pin 60c and 60d contacts the trackball 50 when in the horizontal input status mode and can be received in a respective dimple 62 located on opposite sides of the horizontal axis H and along the vertical axis V.

As mentioned above, the control system 14 includes a plurality of modules (see FIG. 5) that communicate with one another to control operations of the vehicle. The control system 14 includes the trackball control module 44, which communicates with the actuators 64a, 64b, 64c and 64d in the brake assembly to restrict the rotation of the trackball 50 to either about the vertical axis or about a horizontal axis. As mentioned above, the vehicle interface system 10 could operate in additional input status modes, which may require modification of the brake assembly. With reference back to the illustrated embodiment, the trackball control module 44 can operate in vertical input status mode such that the trackball 50 rotates about the horizontal axis H (FIG. 2), which allows an operator of the trackball 50 to scroll through a vertically aligned list of vehicle systems presented on the display 12 in FIG. 1 by manipulating the trackball 50 such that the trackball rotates about the horizontal axis H. Moving the trackball results in movement of a visual indicator, e.g. the box 58 in FIG. 1, which allows the operator to make a selection. In another example, the visual indicator could be depicted as highlighting selected text or image (for example “HVAC” could be in bold font while the remainder of the vehicle systems, “AUDIO,” “VIDEO,” “NAVIGATION” are in regular font) to allow an operator to select a vehicle system to be controlled by the user interface 16.

The trackball control module 44 can further be configured to determine the input status mode based on a setting for the vehicle system selected to be controlled by an operator of the user interface 16 and corresponding to the selected vehicle system. With reference to FIG. 3 for example, an operator of the user interface 16 has selected the audio system to be controlled by selecting, for example “AUDIO” from the display screen depicted in FIG. 1. By selecting an additional setting for the audio system, e.g. a radio station setting, information that is shown in FIG. 3 can be presented on the display 12. With the display 12 presenting the information shown in FIG. 3, the operator of the user interface 16 can select a radio station setting with the trackball control module 44 operating in the horizontal input status mode (see FIG. 4) where rotation of the trackball 50 is restricted to about the vertical axis. Movement of the trackball in the horizontal direction can result in movement of the pointer 56 (as well as an increase or a decrease in the frequency setting, which can be shown numerically on the display).

Accordingly, where it is desirable to allow the operator of the trackball 50 to provide directional input in a left-to-right or a right-to-left direction, e.g., the radio station setting for an audio system, the trackball control module 44 can communicate with the brake assembly to restrict rotation of the trackball 50 to about a vertical axis V (see also FIG. 4). For example, when an associated vehicle system is an audio system, and a selected setting is a radio station setting, the trackball control module 44 is configured to operate in the horizontal input status mode, which allows for the operator to input directional input via the trackball 50 in a horizontal direction. When, however, it is desirable to allow the operator to provide directional input in an up and down direction (see FIG. 1), the trackball control module 44 can communicate with the brake assembly to restrict rotation of the trackball 50 to about the horizontal axis H. For example, when an associated vehicle system is an audio system, and a selected setting is a volume setting, the trackball control module 44 is configured to operate in a vertical input status mode, which allows for the operator to input directional input via the trackball 50 in an up and down direction. The aforementioned examples are simply examples, the desired directional input can be a function of the vehicle system or setting being controlled at that time by the trackball 50.

When the trackball control module 44 is operating in the vertical input status mode, the display control module 42 can communicate with the display 12 to display information in a format conducive to allowing the operator of the vehicle to maneuver the visual indicator in an up and down direction. With reference to FIG. 1, vehicle systems to be controlled by the user interface 16 are listed in a vertically oriented manner, which provides an indication to the operator of the trackball 50 to scroll through the vehicle systems by maneuvering the trackball 50 in an upward or a downward direction. Restricting the rotation of the trackball 50 to about a horizontal axis when in the vertical input status mode, also provides an indication to the vehicle operator to provide the directional input in either an upward or downward direction. When the trackball control module 44 operates in the horizontal input status mode, the display control module 42 can communicate with the display 12 to present information in an orientation conducive to directional input in a left-to-right or a right-to-left direction. In the example depicted in FIG. 3, operators are accustomed to a radio dial moving in the left-to-right or the right-to-left direction. Accordingly, restricting the rotational axis for the trackball 50 to about a vertical axis V and presenting the radio dial shown in FIG. 3 provide an indication to the operator of the vehicle that directional input is desired in a leftward direction or a rightward direction. Other display screens can be displayed on the display 12 that can provide an indication as to the directional input desired by the operator. For example, lit bars and unlit bars having an increase in height from left to right could be provided where a volume setting is desired for the audio system or the video system.

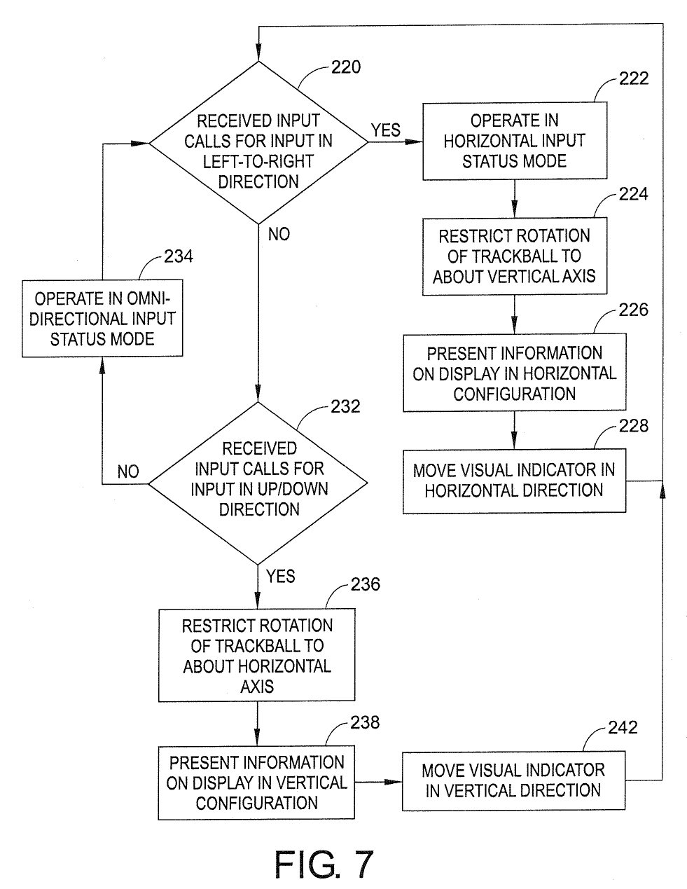

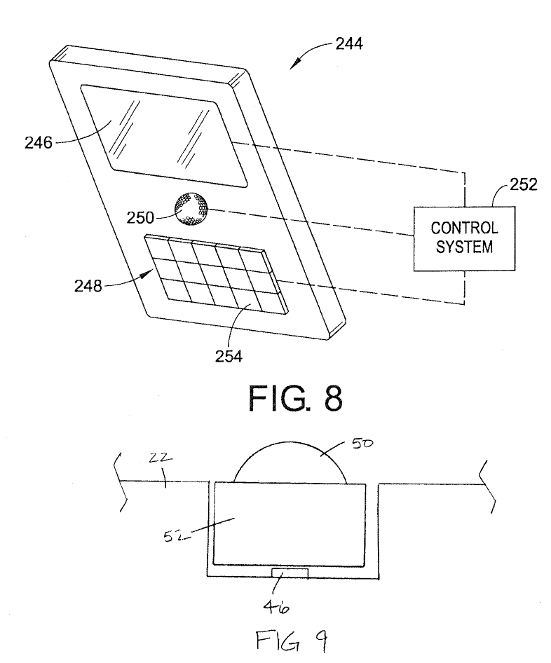

FIGS. 6 and 7 depict flow charts relevant to a method of receiving input via a user interface. The user interface can be located within a vehicle, or the user interface can be associated with another electronic device, e.g. the device depicted in FIG. 8 or another electronic device including a trackball. The flow charts are provided for understanding examples of a method for receiving input via the user interface; however, the invention, which is defined by the appended claims, is not limited to the arrangement of steps as shown in FIGS. 6 and 7. Although each of the blocks in the diagram shown in FIGS. 6 and 7 are described sequentially in a logical order, it is not to be assumed that the system processes the described information in any particular order or arrangement unless otherwise indicated.

With reference to FIG. 6, a method for receiving input via a vehicle user interface, such as the user interface 16 depicted in FIG. 1, is shown to start at 200. Again, the method for receiving input via a user interface need not be through the user interface 16 that is found in a vehicle, but instead could be practiced with another electronic device that includes a trackball. The method described below can restrict rotation of a trackball, e.g. the trackball 50 (or the trackball 250—see FIG. 8, described below), to about a single axis of the trackball based on a determined input status mode, which can be based on the desired directional input of the trackball.

At 202 input is received into a control system, such as the control system 14 depicted in FIG. 1, in a vehicle from a user interface, such as the user interface 16 depicted in FIG. 1. With reference back to FIG. 1, input can be received into the control system by an operator maneuvering the trackball 50 and/or depressing one of the buttons 34 on the user interface 16. As described above, the display 12 can also include a touch screen through which input can be received into the control system or input can be received by depressing the trackball 50 into the housing 52 via the trackball switch 46.

With reference back to FIG. 6, the method for receiving input via a user interface can also include, at 204, determining an input status mode based desired directional movement of the trackball on the user interface. The desired directional input can be based on the input received from the user interface. This will be more particularly described with reference to FIG. 7, which is described in more detail below. For example, with reference back to FIG. 3, where the operator has selected “AUDIO” on the display screen that was shown in FIG. 1, and the operator has selected to control a radio station setting, the trackball control module 44 can determine to operate in a horizontal input status mode, where rotation of the trackball 50 is restricted about the vertical axis V, based on the input received from the user interface 16. The input status mode can also be based on a default mode when the user interface is initially turned on. For example, the vehicle user interface can operate in the horizontal input status mode, the vertical input status mode or the omni-directional input status mode when the ignition switch for the vehicle is turned on.

With reference back to FIG. 6, the method for receiving input via a user interface can also include, at 208, restricting rotation of the trackball 50 (FIG. 1), which is in electrical communication with the control system 14 (FIG. 1), based on the determined input status. For example, when the input status mode is determined to be a horizontal input status mode, rotation of the trackball 50 can be limited to about the vertical axis V, which is shown in FIG. 4. The method for receiving input via a user interface can end at 210.

With reference to FIG. 7, determining an input status mode (step 204 in FIG. 6) can include determining an input status mode including a horizontal input status mode and a vertical input status mode, as well as an omni-directional mode. As mentioned above, however, the vehicle interface system can operate in a fewer or greater number of input status modes. For example, at 220, the control system 14 (FIG. 5) can determine whether the received input (step 202 in FIG. 6) calls for later input in a left-to-right or right-to-left (horizontal) direction. If it is determined that the received input calls for later input in the horizontal direction, then at 222 the trackball control module 44 can operate in a horizontal input status mode, which is shown in FIG. 4. Accordingly, at 224, the rotation of the trackball 50 can be restricted to about the vertical axis V (FIG. 4). At 226 information can be presented on the display 14 (FIG. 3) in a horizontal configuration, e.g. in an orientation conducive to directional input in a left-to-right or a right-to-left direction. At 228, the visual indicator, e.g. the pointer 56 (FIG. 3) can be moved in a horizontal direction in response to horizontal movement of the trackball 50. The method for determining an input status mode can revert back to 220 when further input is received into the user interface 16.

If, however, the received input from step 202 in FIG. 6 calls for the next input to not be in the left-to-right (horizontal) direction, then at 232 it can be determined whether the received input calls for the next input to be an up/down direction. If the received input, for example from step 202 in FIG. 6, does not call for the next input to be in an up/down direction, the control system 14 can operate in an omni-directional input mode, at 234, where the trackball 50 is allowed to rotate about a plurality of axes and revert back to 220 until further input is received. If, however, it is determined that the received input calls for input in the up/down direction, then rotation of the trackball 50 (FIG. 2) can be restricted about the horizontal axis H and at 236. At 238, information can be presented on the display 12 in a vertical configuration (see FIG. 1), e.g., in a format conducive to allowing the operator of the vehicle to maneuver the visual indicator in an up and down direction. At 242, the visual indicator, e.g. the box 58 (FIG. 1) can be moved in a vertical direction in response to vertical movement of the trackball 50. The method for determining an input status mode can revert back to 220 when further input is received into the user interface 16.

As mentioned above, the user interface need not be associated with a vehicle. For example, FIG. 8 depicts an electronic device 244 including a user interface system including a display 246 and a user interface 248 including a trackball 250. The electronic device 244, and thus the user interface system for the electronic device, can include a brake assembly, which is similar to the brake assembly depicted in FIG. 2. Accordingly, further description of the brake assembly is not provided.

The electronic device 244, and thus the user interface for the electronic device, also includes a control system 252 (depicted schematically in FIG. 8). The control system 252 in FIG. 8 is similar to the control system 14, described above. The control system 252 is in electrical communication with the display 246, the trackball 250 as well as other sensors and switches, which for example can be actuated by keys or buttons 254, which can make up components of the user interface. Similar to the control system 14 described above, the control system 252 can also include a trackball control module (not shown in FIG. 8) similar to the trackball control module 44, which can communicate with the brake assembly to restrict rotational movement of the trackball to about predetermined axes. The control system 252 can also be configured to operate in different input status modes, similar to the control system 14 described above. Accordingly, further description of the control system 252 is not provided.

The electronic device 242 shown in FIG. 8 need not be found in a vehicle. The electronic device 242 can be a mobile phone, a computer, a key fob, or another electronic device that includes a processor (or similar device) and a user interface including a trackball and a display, that an operator uses to perform a function or operation.

User interface systems and a method for receiving input via a user interface have been described with particularity above. Modifications and alterations will occur upon reading and understanding the preceding detailed description. For example, the trackball can be restricted to rotate about axes that are neither vertical nor horizontal. The invention is not limited to only the embodiments described above. Instead, the invention is broadly defined by the appended claims and the equivalents thereof.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A user interface system comprising:
a display;
a user interface including a trackball;
a brake assembly configured to cooperate with the trackball to limit rotational movement of the trackball to about predetermined axes; and
a control system in electrical communication with the display, the user interface, and the brake assembly, the control system configured to operate in at least one input status mode including a first input status mode and a second input status mode based on desired directional input of the trackball, the control system including a trackball control module, when in the first input status mode the trackball control module communicates with the brake assembly to restrict rotation of the trackball to about a first axis, when in the second input status mode the trackball control module communicates with the brake assembly to restrict rotation of the trackball to about a second axis.

2. The system of claim 1, wherein the control system includes a display control module, when in the first input status mode the trackball control module communicates the brake assembly to restrict rotation of the trackball to about a horizontal axis and the display module communicates with the display to present a vertically oriented list of commands or selections, wherein movement of the trackball about the horizontal axis results in movement of a visual indicator on the display in a vertical direction.

3. The system of claim 1, wherein the control system is configured to determine the input status mode based on input received from the user interface prior to entering into the determined input status mode.

4. The system of claim 3, wherein the control system communicates with the display to present information on the display based on the input received from the user interface.

5. The system of claim 1, further comprising a housing for the trackball and a switch in the housing actuated by the trackball by pressing the trackball into the housing.

6. A vehicle interface system comprising:
a display mounted in a vehicle cabin of a vehicle;
a control system on the vehicle and in electrical communication with the display; and
a user interface mounted in the vehicle cabin and in electrical communication with the control system, the user interface including a trackball, wherein an axis about which the trackball rotates is controlled by the control system based on input received from the user interface.

7. The system of claim 6, wherein the control system is configured to determine at least one input status mode including a first input status mode and a second input status mode based on the input received from the user interface.

8. The system of claim 7, further comprising a brake assembly, wherein the control system includes a trackball control module in communication with the brake assembly, when in the first input status mode the trackball control module communicates with the brake assembly to restrict rotation of the trackball to about a first axis, when in the second input status mode the trackball control module communicates with the brake assembly to restrict rotation of the trackball to about a second axis.

9. The system of claim 8, wherein the brake assembly includes brake members, when in the first input status mode at least one brake member contacts the trackball to limit rotation of the trackball to about a horizontal axis, and when in the second input status mode at least one brake member contacts the trackball to limit rotation of the trackball to about a vertical axis.

10. The system of claim 7, wherein the control system communicates with the display to present information on the display based on the input received from the user interface and desired directional input of the trackball.

11. The system of claim 6, further comprising at least one vehicle system control module for controlling a vehicle system via commands inputted through the user interface, wherein the control system is configured to determine an input status mode based on the vehicle system selected to be controlled by an associated operator via the user interface.

12. The system of claim 11, wherein the control system is further configured to determine the input status mode based on a setting selected to be controlled by the associated operator of the user interface and corresponding to the vehicle system selected to be controlled by the associated operator of the user interface.

13. The system of claim 12, wherein when the selected vehicle system is an audio system, and the selected setting is a radio station setting, the control system is configured to operate in a horizontal input status mode.

14. The system of claim 6, further comprising a brake assembly in communication with the control system, wherein the brake assembly is configured to cooperate with the trackball to limit rotational movement of the trackball to two mutually perpendicular axes, wherein the brake assembly includes a plurality of pins and respective actuators, wherein at least two horizontal pins align along a horizontal axis extending through a center of the trackball and at least two vertical pins align along a vertical axis extending through the center of the trackball, wherein each horizontal pin is moveable by a respective actuator in the horizontal axis and each vertical pin is moveable by a respective actuator in the vertical axis.

15. A method for receiving input via a user interface, the method comprising:
determining an input status mode based on desired directional movement of a trackball on a user interface, wherein the trackball is in electrical communication with a control system that is also in communication with the user interface; and
restricting rotation of the trackball to about a single axis of the trackball based on the determined input status mode.

16. The method of claim 15, further comprising receiving input into the control system from the user interface, wherein determining an input status mode further includes determining the input status mode based on the received input from the user interface.

17. The method of claim 16, wherein receiving input into a control system from the user interface includes receiving a selection from the user interface of a vehicle system to be controlled.

18. The method of claim 17, wherein receiving input into a control system from the user interface includes receiving a setting command from the user interface for the vehicle system that is to be controlled.

19. The method of claim 16, wherein determining an input status mode includes determining an input status mode including a horizontal input status mode and a vertical input status mode, and when in the horizontal input status mode restricting rotation of the trackball includes restricting rotation of the trackball to about a vertical axis, and when in the vertical input status mode restricting rotation of the trackball includes restricting rotation of the trackball to about a horizontal axis.

20. The method of claim 19, further comprising presenting information on a display mounted in a vehicle cabin of the vehicle, wherein when the horizontal input status mode is determined presenting information on the display includes presenting information in a horizontal configuration, and when the vertical input status mode is determined presenting information on the display includes presenting information in a vertical configuration.
